(19) United States
(12) Patent Application Publication
(10) Pub. No.: US 2012/0308037 A1
(43) Pub. Date: Dec. 6, 2012

(54) MICROELECTROMECHANICAL MICROPHONE CHIP HAVING STEREOSCOPIC DIAPHRAGM STRUCTURE AND FABRICATION METHOD THEREOF

(76) Inventors: Hung-Jen CHEN, Taichung (TW); Kuan-Hsun Chiu, Taichung (TW); Ming-Li Hsu, Taichung (TW); Xian-Gen Liao, Taichung (TW)

(21) Appl. No.: 13/153,074

(22) Filed: Jun. 3, 2011

(51) Int. Cl. H04R 3/00; H04R 31/00

(52) U.S. Cl. 381/92; 29/594

(57) ABSTRACT

A microelectromechanical microphone chip having a stereoscopic diaphragm structure includes a base, having a chamber; a diaphragm, disposed on the chamber and having steps with height differences; and a back plate, disposed on the diaphragm, forming a space with the diaphragm in between, and having a plurality of sound-holes communicating with the space.

### BACKGROUND OF THE INVENTION

1. Field of Invention

The present invention relates to a microelectromechanical microphone chip, and more particularly to a microelectromechanical microphone chip having a stereoscopic diaphragm structure and a fabrication method thereof.

2. Related Art

A microelectromechanical microphone is a product strongly developed in the electroacoustic industry, which can be widely applied on various portable electronic devices, thereby conforming to requirements of miniaturization and having an effect of collecting sounds.

FIG. 1 is a schematic view of a conventional microelectromechanical microphone chip. The microelectromechanical microphone chip includes a base 1, on which a fixed electrode 2 is disposed. The fixed electrode 2 supports a diaphragm 4 thereunder by using a support piece 3. When the diaphragm 4 is deformed due to release of residual stress, an acting force may be generated through binding of the support piece 3 to the fixed electrode 2, so that a central area of the fixed electrode 2 is deformed, which is synchronous with deformation of the diaphragm 4, and an arc-like deformation structure is generated. It is intended that this deformation effect not only absorbs the residual stress of the diaphragm 4, but also makes a structural surface of the central area remain planar, and that the capacitance gap distance formed between the fixed electrode 2 and the diaphragm 4 can remain invariable.

However, for the microelectromechanical microphone chip, generally the difference between the structural thicknesses of the fixed electrode 2 and the diaphragm 4 is large. The double-layered structural design bound by the support piece 3 makes the arc deformation structure release the residual stress of the diaphragm 4, which makes it difficult to obtain an intended planar result for surfaces of the diaphragm 4 and the fixed electrode 2. When a surface of the diaphragm 4 has any deformation relief, the capacitance gap distance between the fixed electrode 2 and the diaphragm 4 is changed in a localized area; therefore, when a sound wave is vibrated through the diaphragm 4, a serious harmonic distortion phenomenon occurs.

In the structural design, the support piece 3 of a heterogeneous material is fabricated between the fixed electrode 2 and the diaphragm 4. For the fabrication process, the technique is very difficult, and the cost is relatively high. Furthermore, how to fabricate individual conductive layers on the diaphragm 4 and the fixed electrode 2 and form a capacitor construction between two conductive layers and how to draw signal wires of the diaphragm 4 out to a solder pad position are the difficulties and challenges for the structural design.

### SUMMARY OF THE INVENTION

Accordingly, the present invention is directed to a microelectromechanical microphone chip having a stereoscopic diaphragm structure and a fabrication method thereof, in which a suspension diaphragm having a plurality of stepped layers and a back plate corresponding to a profile of the diaphragm are fabricated on a base, so that an effective area of the diaphragm is increased, thereby increasing sensitivity.

To achieve the above objective, the present invention provides a microelectromechanical microphone chip having a stereoscopic diaphragm structure, which comprises a base, having a chamber; a diaphragm, disposed on the chamber and having steps with height differences; and a back plate, adjacent to the diaphragm, keeping a distance from the diaphragm, and having a plurality of sound-holes. Accordingly, since the diaphragm has a plurality of stepped layers, the diaphragm has a larger effective area than that of a conventional diaphragm, thereby increasing sensitivity of vibration and further improving acoustical performances of the microelectromechanical microphone chip.

Moreover, to achieve the above objective, the present invention provides a method for fabricating a microelectromechanical microphone chip having a stereoscopic diaphragm structure, which comprises: providing a base; forming a diaphragm having steps with height differences and a back plate on the base, in which the back plate has a plurality of sound-holes; forming a chamber within the base so that the diaphragm forms a suspension structure; and forming a space between the back plate and the diaphragm to fabricate the microelectromechanical microphone chip. Accordingly, through fabrication manners such as a sacrificial layer, wet etching, and deposition in microelectromechanical technologies, the diaphragm of a stereoscopic structure is formed, so that compared with a conventional manufacturing manner, the present invention has advantages in processing and manufacturing, and the microelectromechanical microphone chip according to the present invention effectively reduces the manufacturing cost.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a conventional microelectromechanical microphone chip;

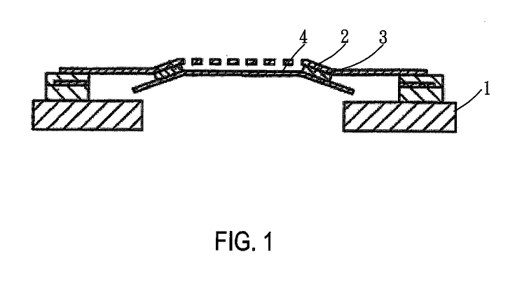

FIG. 2 is a schematic view of forming a sacrificial layer on a base according to a first embodiment of the present invention;

FIG. 3 is schematic view of forming round corners of the sacrificial layer according to the first embodiment of the present invention;

FIG. 4 is a schematic view of forming a diaphragm on the base according to the first embodiment of the present invention;

FIG. 5 is a schematic view of forming a sacrificial layer on the diaphragm according to the first embodiment of the present invention;

FIG. 6 is schematic view of forming a dielectric layer on the sacrificial layer according to the first embodiment of the present invention;

FIG. 7 is schematic view of forming a back plate according to the first embodiment of the present invention;

FIG. 8 is a schematic view of forming a chamber in the base according to the first embodiment of the present invention;

FIG. 9 is a schematic view of a microelectromechanical microphone chip according to the first embodiment of the present invention;

FIG. 10 is a schematic view of a microelectromechanical microphone chip according to a second embodiment of the present invention;

FIG. 11 is a schematic view of forming a first groove in a base according to a third embodiment of the present invention;

FIG. 12 is a schematic view of forming a second groove in the base according to the third embodiment of the present invention;

FIG. 13 is schematic view of forming a back plate according to the third embodiment of the present invention;

FIG. 14 is a schematic view of forming an insulation layer according to the third embodiment of the present invention;

FIG. 15 is a schematic view of forming a sacrificial layer according to the third embodiment of the present invention;

FIG. 16 is a schematic view of forming a diaphragm according to the third embodiment of the present invention;

FIG. 17 is schematic view of forming a chamber according to the third embodiment of the present invention;

FIG. 18 is a schematic view of a microelectromechanical microphone chip according to the third embodiment of the present invention; and

FIG. 19 is a schematic view of a microelectromechanical microphone chip according to a fourth embodiment of the present invention.

### DETAILED DESCRIPTION OF THE INVENTION

Embodiments of a microelectromechanical microphone chip having a stereoscopic diaphragm structure and a fabrication method thereof according to the present invention are described below with reference to accompanying drawings.

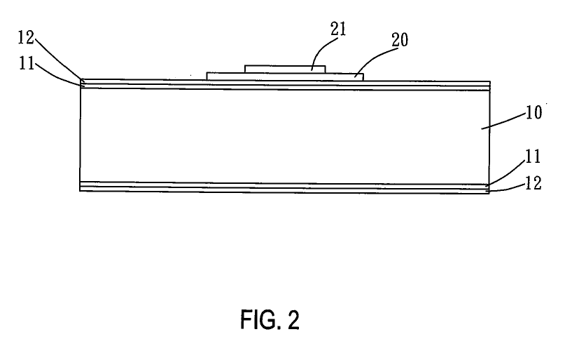

FIG. 2 is a schematic view of forming a sacrificial layer on a base according to the present invention. A base 10 of a silicon material is first provided. A silicon dioxide layer 11 and a silicon nitride layer 12 are sequentially formed on an upper surface and a lower surface of the base 10 respectively. Step layers of a first sacrificial layer 20 and a second sacrificial layer 21 are deposited on the upper surface of the base 10 respectively, in which the second sacrificial layer 21 is disposed on the first sacrificial layer 20, a transverse width of the second sacrificial layer 21 is smaller than that of the first sacrificial layer 20, and both the first sacrificial layer 20 and the second sacrificial layer 21 may select a silicon oxide material.

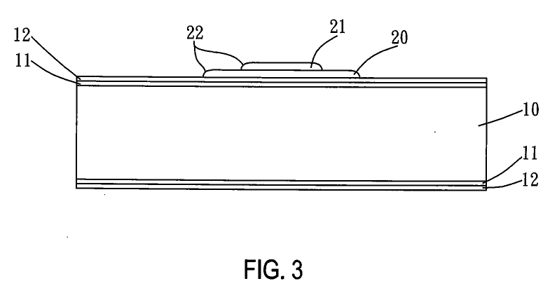

FIG. 3 is a schematic view of forming round corners of the sacrificial layer according to the present invention. Two sides of the first sacrificial layer 20 and two sides of the second sacrificial layer 21 are etched in a wet etching manner, so that edge corners of the first sacrificial layer 20 and the second sacrificial layer 21 are fabricated into round corners 22.

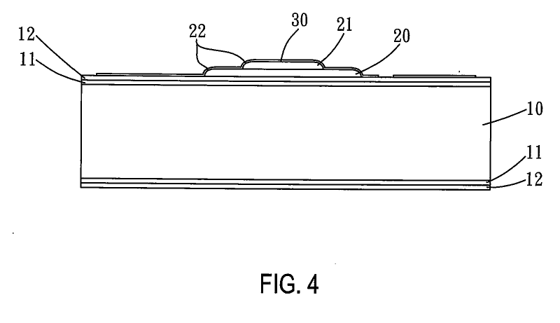

FIG. 4 is a schematic view of forming a diaphragm on the base according to the present invention. A diaphragm 30 is fabricated on the silicon nitride layer 12 on the upper surface of the base 10. The diaphragm 30 is clad on the first sacrificial layer 20 and the second sacrificial layer 21 and formed along profiles of the first sacrificial layer 20 and the second sacrificial layer 21, so that the diaphragm 30 has the round corners 22 of the same arcs as those of the first sacrificial layer 20 and the second sacrificial layer 21. The number of step layers of the diaphragm 30 depends on the number of the sacrificial layers, so an additional sacrificial layer may be disposed on the second sacrificial layer 21 according to product requirements, so that the number of the step layers of the diaphragm 30 can be increased.

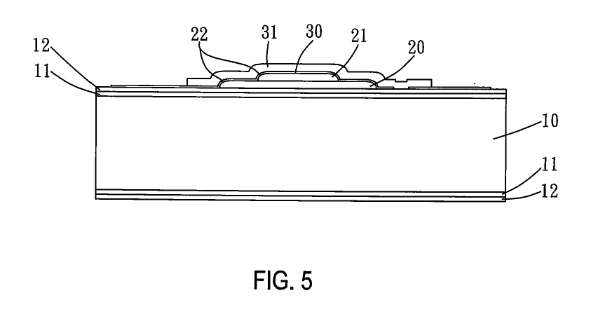

FIG. 5 is a schematic view of forming a sacrificial layer on the diaphragm according to the present invention. A third sacrificial layer 31 is deposited on the diaphragm 30 and formed along a profile of the diaphragm 30.

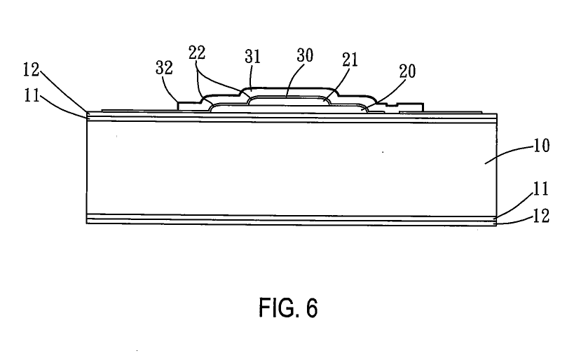

FIG. 6 is a schematic view of forming a dielectric layer on the sacrificial layer according to the present invention. A dielectric layer 32 is deposited on the third sacrificial layer 31.

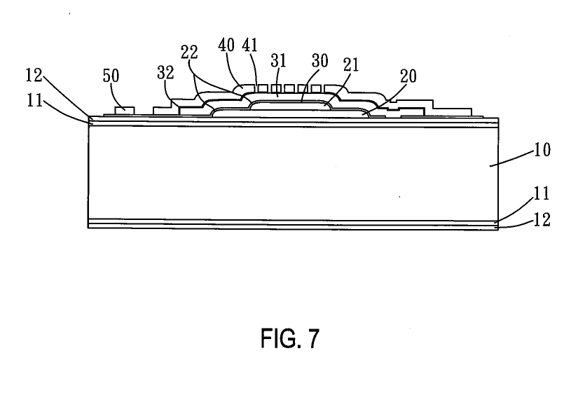

FIG. 7 is a schematic view of forming a back plate according to the present invention. A back plate 40 is fabricated on the diaphragm 30 and the dielectric layer 32. A plurality of sound-holes 41 is formed in a central region of the back plate 40 through etching. A metal pad 50 is fabricated at a lateral side and located on a predetermined pattern of the diaphragm 30. The back plate 40 is formed along a profile of the dielectric layer 32.

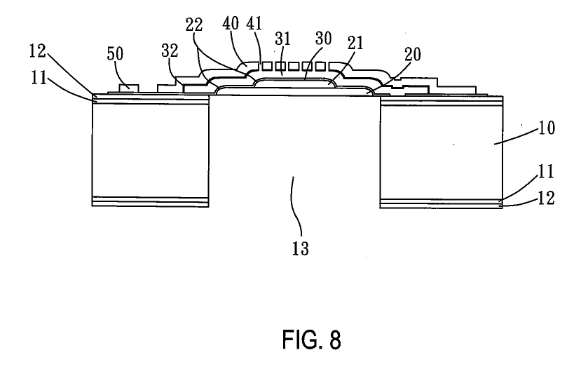

FIG. 8 is a schematic view of forming a chamber in the base according to the present invention. Then, a chamber 13 is etched from the bottom of the base 10 towards the diaphragm 30, and the silicon dioxide layer 11 and the silicon nitride layer 12 under the diaphragm 30 are etched off.

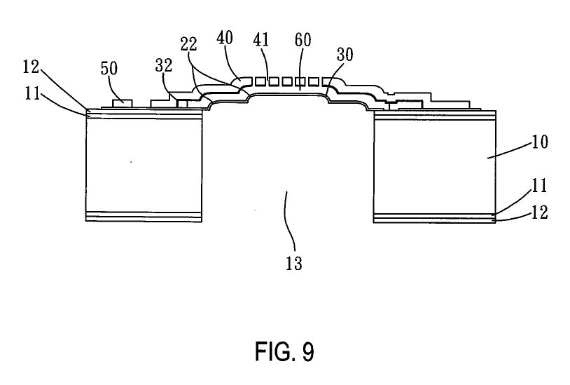

FIG. 9 is a schematic view of a microelectromechanical microphone chip according to a first embodiment of the present invention. Middle parts of the first sacrificial layer 20 and the second sacrificial layer 21 are etched off from the chamber 13 towards the diaphragm 30, so as to form the diaphragm 30 of a suspension structure by etching. A space 60 is formed by etching in a direction from the sound-holes 41 to the diaphragm 30, in which the sound-holes 41 communicate with the space 60, thereby etching the third sacrificial layer 31 and the dielectric layer 32 on the diaphragm 30 off, so as to form the stepped diaphragm 30 having a height difference and having the round corners 22. Moreover, the dielectric layer 32 is disposed to prevent the diaphragm 30 from contacting the back plate 40. Furthermore, an inner edge shape of the back plate 40 corresponds to an outer edge of the diaphragm 30. In this way, the fabrication of the microelectromechanical microphone chip is completed.

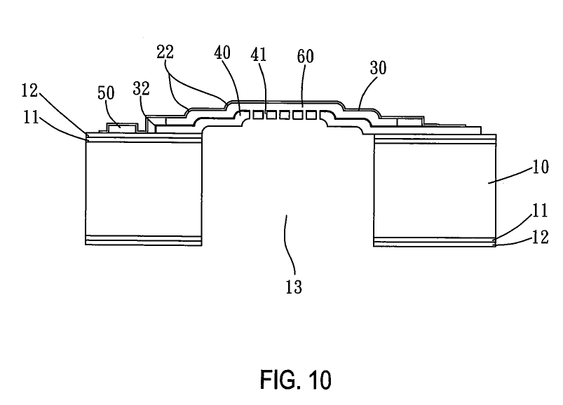

FIG. 10 is a schematic view of a microelectromechanical microphone chip according to a second embodiment of the present invention. The difference between this embodiment and the first embodiment is that, the diaphragm 30 is disposed on the back plate 40, so during fabrication, the back plate 40 is first formed, and then the diaphragm 30 is formed.

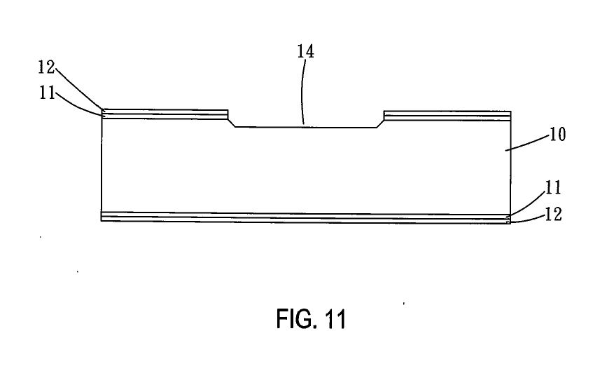

FIG. 11 is a schematic view of forming a first groove in a base according to a third embodiment of the present invention. The difference between this embodiment and the first embodiment is that, a first groove 14 is formed in the upper surface of the base 10 in an etching manner.

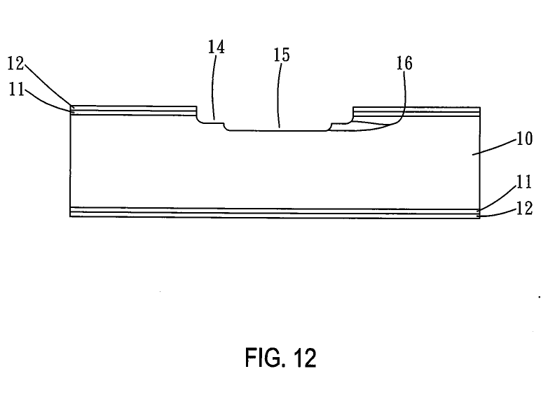

FIG. 12 is a schematic view of forming a second groove in the base according to the third embodiment of the present invention. Following the foregoing step, a second groove 15 is formed by etching downwards in the first groove 14, or a second groove 15 is formed by etching in a larger scale from inside to outside of the first groove 14. Round corner structures 16 are formed at the corners of the first groove 14 and the second groove 15.

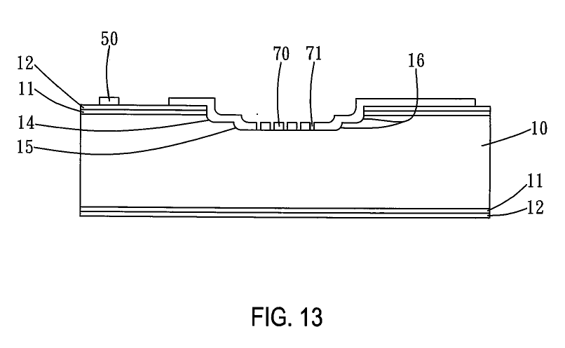

FIG. 13 is a schematic view of forming a back plate according to the third embodiment of the present invention. Then, a back plate 70 having a plurality of sound-holes 71 is deposited on the base 10 and in the first groove 14 and the second groove 15 and formed along profiles of the first groove 14 and the second groove 15. Since the formation of the first groove 14 and the second groove 15 with height differences, the back plate 70 may have a step shape. When the back plate 70 is formed, a metal pad 50 is formed at a lateral side and located on a predetermined pattern of the base 10.

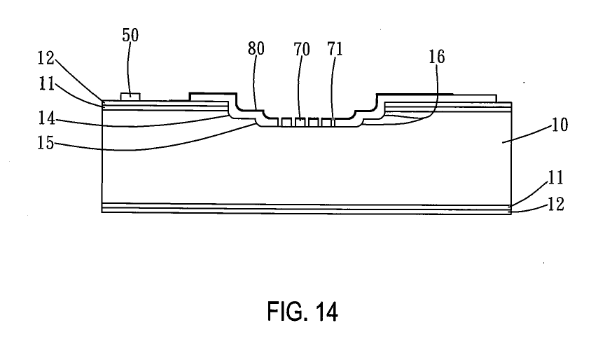

FIG. 14 is a schematic view of forming an insulation layer according to the third embodiment of the present invention. An insulation layer 80 is deposited on the back plate 70. The insulation layer 80 may adopt a silicon nitride material.

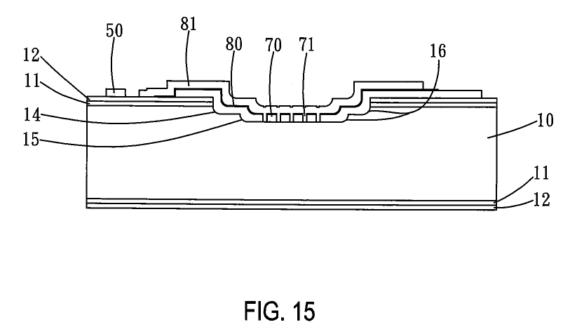

FIG. 15 is a schematic view of forming a sacrificial layer according to the third embodiment of the present invention. A sacrificial layer 81 is deposited on the insulation layer 80.

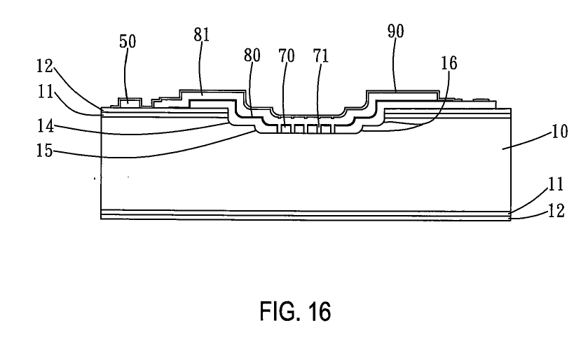

FIG. 16 is a schematic view of forming a diaphragm according to the third embodiment of the present invention. A diaphragm 90 is deposited and clad on the sacrificial layer 81 and formed along a profile of the sacrificial layer 81. The diaphragm 90 has the same round corner structure as those of the first groove 14 and the second groove 15.

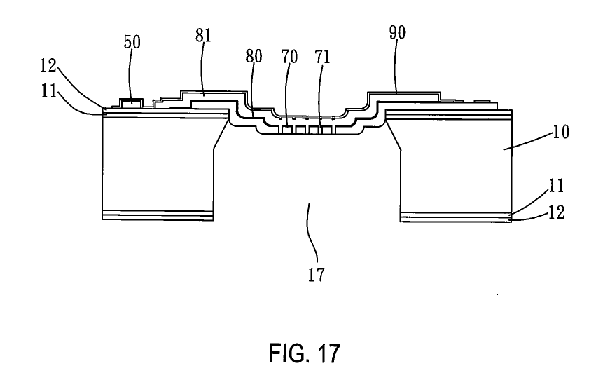

FIG. 17 is a schematic view of forming a chamber according to the third embodiment of the present invention. Then, the base 10 is etched from the bottom thereof towards the back plate 70, and the silicon dioxide layer 11 and the silicon nitride layer 12 on the upper surface of the base 10 are also etched, so as to form a chamber 17.

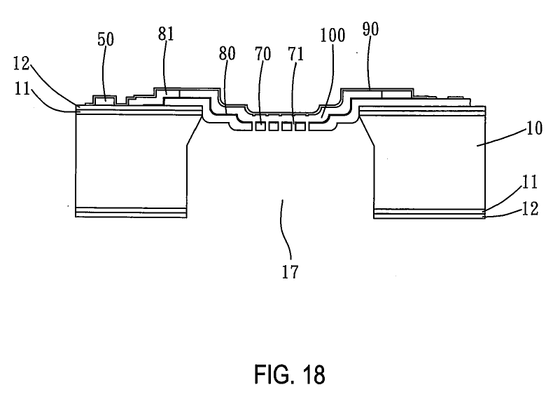

FIG. 18 is a schematic view of a microelectromechanical microphone chip according to the third embodiment of the present invention. The insulation layer 80 is etched through in a direction from the chamber 17 towards the diaphragm 30, the sacrificial layer 81 between the back plate 70 and the diaphragm 90 is etched off, so as to form a space 100, and the sound-holes 71 communicate with the space 100, so that the diaphragm 90 becomes a suspension structure. In this way, the fabrication of the microelectromechanical microphone chip is completed.

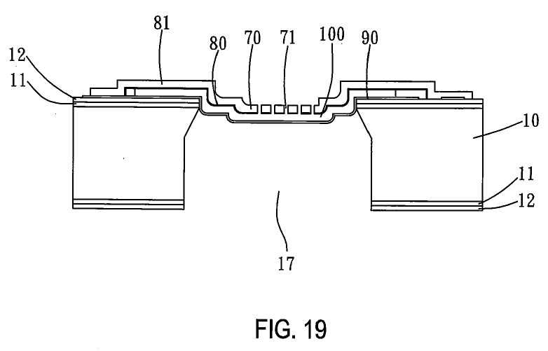

FIG. 19 is a schematic view of a microelectromechanical microphone chip according to a fourth embodiment of the present invention. The difference between this embodiment and the third embodiment is that, the back plate 70 is disposed on the diaphragm 90, so during fabrication, the diaphragm 90 is first formed, and then the back plate 70 is formed.

The steps and the round corners formed by the back plate and the diaphragm according to the present invention can increase an effective area of the diaphragm required by the capacitor construction. Therefore, compared with a conventional straight diaphragm, the diaphragm according to the present invention can increase sensitivity of vibration and improve performances thereof. Furthermore, the diaphragm according to the present invention has round corners, which can avoid stress concentrated at a corner of the diaphragm, thereby reducing structural damage.

Through the microelectromechanical technology using the wet etching and the sacrificial layer according to the present invention, the diaphragm of a plurality of stepped layers is formed on the base, and the step corners of the diaphragm become the round corners, so that not only the diaphragm has a preferable effective area to increase the sensitivity of vibration, but also the round corners further enable the diaphragm to alleviate the stress concentration to avoid structural damage, thereby improving the performances of the microelectromechanical microphone chip. Meanwhile, according to the present invention, a groove can also be formed by etching on the base first to deposit the back plate and the diaphragm, which likewise has the foregoing effects.

The above embodiments are only exemplary embodiments and not intended to limit the present invention. Any equivalent modification or change made without departing from the spirit and scope of the present invention shall be all covered in the appended claims.

What is claimed is:

1. A microelectromechanical microphone chip having a stereoscopic diaphragm structure, comprising:
a base, having a chamber;
a diaphragm, disposed on the chamber and having steps with height differences; and
a back plate, adjacent to the diaphragm, keeping a distance from the diaphragm, and having a plurality of sound-holes.

2. The microelectromechanical microphone chip having the stereoscopic diaphragm structure according to claim 1, wherein the steps of the diaphragm are two stepped layers.

3. The microelectromechanical microphone chip having the stereoscopic diaphragm structure according to claim 2, wherein a transverse width of a top step layer of the diaphragm is not equal to a transverse width of a bottom step layer.

4. The microelectromechanical microphone chip having the stereoscopic diaphragm structure according to claim 1, wherein a shape of an inner edge of the back plate corresponds to a shape of an outer edge of the diaphragm.

5. The microelectromechanical microphone chip having the stereoscopic diaphragm structure according to claim 4, wherein edge corners of the steps of the diaphragm are a round corner structure.

6. The microelectromechanical microphone chip having the stereoscopic diaphragm structure according to claim 1, wherein a silicon dioxide layer exists between the base and the diaphragm.

7. The microelectromechanical microphone chip having the stereoscopic diaphragm structure according to claim 6, wherein a silicon nitride layer is disposed between the diaphragm and the silicon dioxide layer.

8. A method for fabricating a microelectromechanical microphone chip having a stereoscopic diaphragm structure, comprising:
providing a base;
forming a diaphragm having steps with height differences and a back plate on the base, wherein the back plate has a plurality of sound-holes;
forming a chamber in the base so that the diaphragm forms a suspension structure; and
forming a space between the back plate and the diaphragm to fabricate the microelectromechanical microphone chip.

9. The method for fabricating the microelectromechanical microphone chip having the stereoscopic diaphragm structure according to claim 8, wherein a first sacrificial layer is deposited on an upper surface of the base, a second sacrificial layer is deposited on the first sacrificial layer, the diaphragm is deposited along profiles of the first sacrificial layer and the second sacrificial layer, then a third sacrificial layer is deposited along a profile of the diaphragm, and then the back plate is deposited on the third sacrificial layer.

10. The method for fabricating the microelectromechanical microphone chip having the stereoscopic diaphragm structure according to claim 9, wherein the first sacrificial layer and the second sacrificial layer are etched so that the diaphragm forms the suspension structure.

11. The method for fabricating the microelectromechanical microphone chip having the stereoscopic diaphragm structure according to claim 9, wherein the third sacrificial layer is etched in a direction from the back plate towards the diaphragm to form the space.

12. The method for fabricating the microelectromechanical microphone chip having the stereoscopic diaphragm structure according to claim 9, wherein before the diaphragm is deposited, the first sacrificial layer and the second sacrificial layer are etched through a wet etching to form round corners at edge corners respectively.

13. The method for fabricating the microelectromechanical microphone chip having the stereoscopic diaphragm structure according to claim 8, wherein when the sound-holes are formed, a metal pad is formed on the diaphragm.

14. The method for fabricating the microelectromechanical microphone chip having the stereoscopic diaphragm structure according to claim 9, wherein before the first sacrificial layer is deposited, a silicon dioxide layer and a silicon nitride layer are sequentially formed on the upper surface and a lower surface of the base respectively.

15. The method for fabricating the microelectromechanical microphone chip having the stereoscopic diaphragm structure according to claim 9, wherein before the back plate is deposited, a dielectric layer is formed on the third sacrificial layer.

16. The method for fabricating the microelectromechanical microphone chip having the stereoscopic diaphragm structure according to claim 8, wherein a first groove is formed on the base by etching, a second groove is formed by etching downwards in the first groove, the back plate is deposited in the first groove and the second groove, an insulation layer is deposited on the back plate, then a sacrificial layer is deposited on the insulation layer, and the diaphragm is deposited on the sacrificial layer.

17. The method for fabricating the microelectromechanical microphone chip having the stereoscopic diaphragm structure according to claim 16, wherein round corners are formed at corners of the first groove and the second groove.

18. The method for fabricating the microelectromechanical microphone chip having the stereoscopic diaphragm structure according to claim 16, wherein the second groove is formed by etching in a larger scale from inside to outside of the first groove.

19. The method for fabricating the microelectromechanical microphone chip having the stereoscopic diaphragm structure according to claim 16, wherein when the back plate is formed, a metal pad is formed at a lateral side of the back plate and located on a predetermined pattern of the base.

20. The method for fabricating the microelectromechanical microphone chip having the stereoscopic diaphragm structure according to claim 16, wherein the insulation layer is etched through in a direction from the chamber towards the diaphragm, and then the sacrificial layer between the back plate and the diaphragm is etched, so as to form the space.
